(19) United States
(12) Patent Application Publication
(10) Pub. No.: US 2002/0002583 A1
(43) Pub. Date: Jan. 3, 2002

(54) Method for setting up a communication link between an embedded server and a client computer

(76) Inventors: Andreas Fabri, Le Plan de Grasse (FR); Txomin Nieva, Lausanne (CH); Dominik Auf Der Maur, Zurich (CH)

Correspondence Address: BURNS DOANE SWECKER & MATHIS L L P, POST OFFICE BOX 1404, ALEXANDRIA, VA, 22313-1404, US

(21) Appl. No.: 09/833,729

(22) Filed: Apr. 13, 2001

(30) Foreign Application Priority Data
Apr. 13, 2000 (EP) 00810322.8

(51) Int. Cl. G06F 15/16

(52) U.S. Cl. 709/203

(57) ABSTRACT

A method for communicating with an appliance has the following steps:

a) an embedded server (1) of the appliance, which has means for storing a control program (11) and a component loader (12), transmits the component loader (12) to an application server (2),

b) the component loader (12) in the application server (2) causes a business application (13) stored in a component server (3) to be transmitted to the application server (2),

c) the business application (13) is executed in the application server (2) and effects communication between a client program (14), which is executed on a client computer (4), and the control program (11), which is executed on the embedded server (1).

This permits communication between the client program (14) and the control program (11) to be set up and conducted, the business application (13) used for this purpose being automatically loaded into the application server (2).

The invention relates to the field of industrial automation technology. It relates to a method and to a computer program for setting up a communication link to an appliance in accordance with the precharacterizing clause of patent claims 1 and 7.

To control an appliance or device, a known client-server communication model is frequently used. In this case, the appliance or a control unit for the appliance has a data processing unit or embedded server on which a computer program for controlling and monitoring the appliance is executed. The embedded server is connected to a client computer via a communication link, that is to say a point-to-point link or a computer network. On the client computer, a client application is executed. The client application uses the communication link to send inquiries to the embedded server or to a control program executed on the embedded server. Appropriate responses from the embedded server are processed further by the client application and, by way of example, are displayed for a user. The responses from the embedded server are, as disclosed in U.S. Pat. No. 5,805,442, displayed on the basis of an HTML, XML or related protocol, that the embedded server has a web server for producing the responses. This web server or a corresponding program component for presenting data to the control unit is also called business logic or business application. It is sometimes extensive by comparison with pure control software of the embedded server, and requires a correspondingly large amount of processing time and storage space on the embedded server. For this reason, in a three-stage, so-called “three-tier” architecture, a so-called application server in a further data processing unit is used. The application server contains the web server with the business application and communicates both with the client application and with the embedded server. The application server converts inquiries from the client application into inquiries to the embedded server and converts responses from the embedded server into responses to the client application. This relieves the load on the embedded server. The converted responses are typically more extensive than the responses from the embedded server, so that the load on the communication link to the embedded server is also relieved.

The problem with this three-stage architecture is that of installing in the application server the appropriate business application for an embedded server. This is usually done manually, but this is very complex when there are a large number of appliances. In addition, a lot of effort is required when a system has a large number of appliances and a configuration of these appliances is continuously changing.

It is therefore the object of the invention to provide a method and a computer program for setting up a communication link between an embedded server and a client computer of the type mentioned in the introduction which eliminates the aforementioned disadvantages.

This object is achieved by a method and a computer program for setting up a communication link between an embedded server and a client computer having the features of patent claims 1 and 7.

The method according to the invention for setting up a communication link between an embedded server and a client computer has the following steps:

a) an embedded server of the appliance, which has means for storing a control program and a component loader, transmits the component loader to an application server,

b) the component loader in the application server causes a business application stored in a component server to be transmitted to the application server,

c) the business application is executed in the application server and effects communication between a client program, which is executed on the client computer, and the control program, which is executed on the embedded server.

This permits communication between the embedded server and the client computer, or between the control program and the client program, to be set up and conducted, the business application used for this purpose being automatically loaded into the application server. This eliminates manual installation of the business application. This is advantageous particularly when a number of appliances having a respective dedicated embedded server are frequently connected to an entire system and disconnected from it again.

A further advantage of the invention is that adjustments to the business application can be made centrally in the component server.

In one preferred variant of the invention, the component loader stores information about a network address for the component server.

Further preferred embodiments can be found in the dependent patent claims.

The invention is explained in more detail below with the aid of a preferred exemplary embodiment illustrated in the appended drawings, in which:

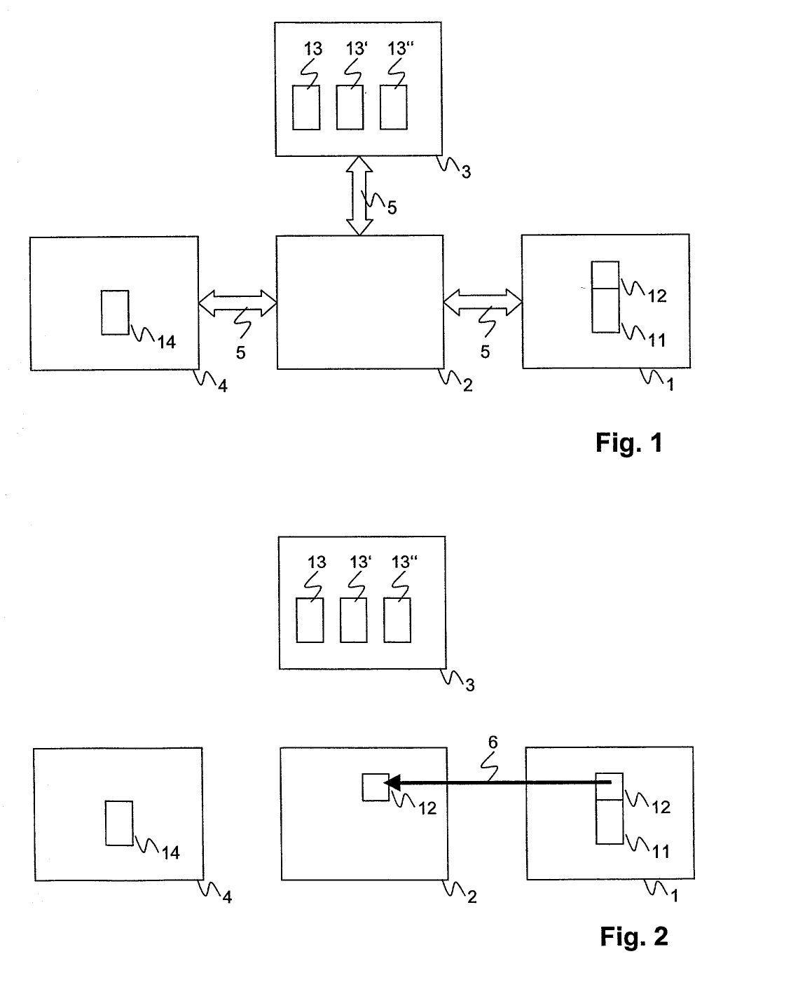

FIG. 1 shows, schematically, a structure of data processing units on which the method according to the invention is carried out; and

FIGS. 2 to 5 show, schematically, a sequence of the method according to the invention.

The reference numerals used in the drawings, and their meanings, are summarized in the list of reference numerals. In principle, identical parts are provided with identical reference numerals in the figures.

FIG. 1 shows, schematically, a structure of data processing units on which the method according to the invention can be carried out. The structure has a first data processing unit or embedded server 1, a second data processing unit or application server 2, a third data processing unit or component server 3 and a fourth data processing unit or client computer 4. Before the start of the method according to the invention, the embedded server 1 stores a first program unit or control program 11 and a second program unit or component loader 12. The component server 3 stores at least one third program unit or business application 13, 13′, 13″, and the client computer 4 stores a fourth program unit or client program 14. The various data processing units are usually physically separate from one another and each have arithmetic and data storage means. Communication between the various data processing units takes place via arbitrary communication links 5 or communication networks, for example over the Internet or an intranet, and on the basis of a generally known protocol, for example the TCP/IP protocol.

The embedded server 1 is a microcomputer which is associated with an appliance and is incorporated in or fitted to this appliance. The embedded server 1 typically has no or just very simple input/output means, such as switches or light-emitting diodes. The control program 11 on the embedded server 1 controls and monitors the appliance, for example, and/or determines and stores operating data for the appliance. Such an appliance is, by way of example, a microturbine or a locomotive. Once switched on, appliances register with a client program 14 in a central control station and set up communication with the client program 14 on the basis of the method according to the invention. The client computer 4 for executing the client program 14 is situated, by way of example, in a control center for monitoring a number of appliances. The communication is used, for example, to transmit, condition and display status information, diagnosis information or other appliance information. As described in the introduction, this communication is handled by means of a business application 13 on an application server 2, in order to relieve the load on the embedded server 1. The application server 2 is situated, by way of example, in an intermediate station between the appliances and the control center. The application server 2 may also be identical to the client computer 4, with the result that the same data processing unit executes both the client program 14 and the business application 13.

The business application 13, or an appropriate program component, converts inquiries from the client program 14, which is executed on the client computer 4, into inquiries to the control program 11, which is executed on the embedded server 1. Responses from the control program 11 are converted into responses to the client program 14 by the business application 13. These inquiries and responses between the control program 11 and the business application 13 are based on a specific protocol which is typical for the appliance or an appliance class. In one preferred variant of the invention, the responses to the client program 14 are based on an HTML protocol, XML protocol or related protocol, with the result that a generic web browser can be used as client program 14. Preferably, the embedded server 1 can be accessed from a plurality of different client computers 4 via the application server 2. In this case, the application server 2 preferably regulates access by permitting access for only authorized client programs 14 and, by way of example, only one client program 14 at the same time.

The aim of the method according to the invention is to load and execute a suitable business application 13 on the application server 2 without the need for manual intervention. To achieve this aim, the embedded server 1 has, in accordance with the invention, the component loader 12. In a preferred embodiment, the component loader 12 is a program in the programming language Java or in a programming language which has comparable loading mechanisms, for example based on Microsoft® technologies.

To set up the communication, described above, with the control program 11, the method according to the invention has the following steps:

FIG. 2 shows, schematically, a first step in the method according to the invention. In this step, the component loader 12 is transmitted from the embedded server 1 to the application server 2 via a communication link 5 (not shown) or a network. For this transmission, a network or IP address for the application server 2 is required. This address is, by way of example, already stored in the embedded server 1, or, by way of example, is ascertained by means of a known Jini mechanism using a lookup server. In the case of this mechanism, the component loader 12 or another program unit on the embedded server 1 transmits a multicast message in order to register with a lookup server. A lookup server managing such services as are offered by the embedded server 1 registers the embedded server 1. The embedded server 1 transmits the component loader 12 to the lookup server, the component loader 12 containing, in particular, an IP address for the embedded server 1. At an arbitrary later instant, the application server 2 asks the lookup server which services of interest to the application server 2 are available. In response, the lookup server transmits the component loader 12 to the application server 2. The result of this mechanism is thus the indirect transmission 6 of the component loader 12 from the embedded server 1 to the application server 2.

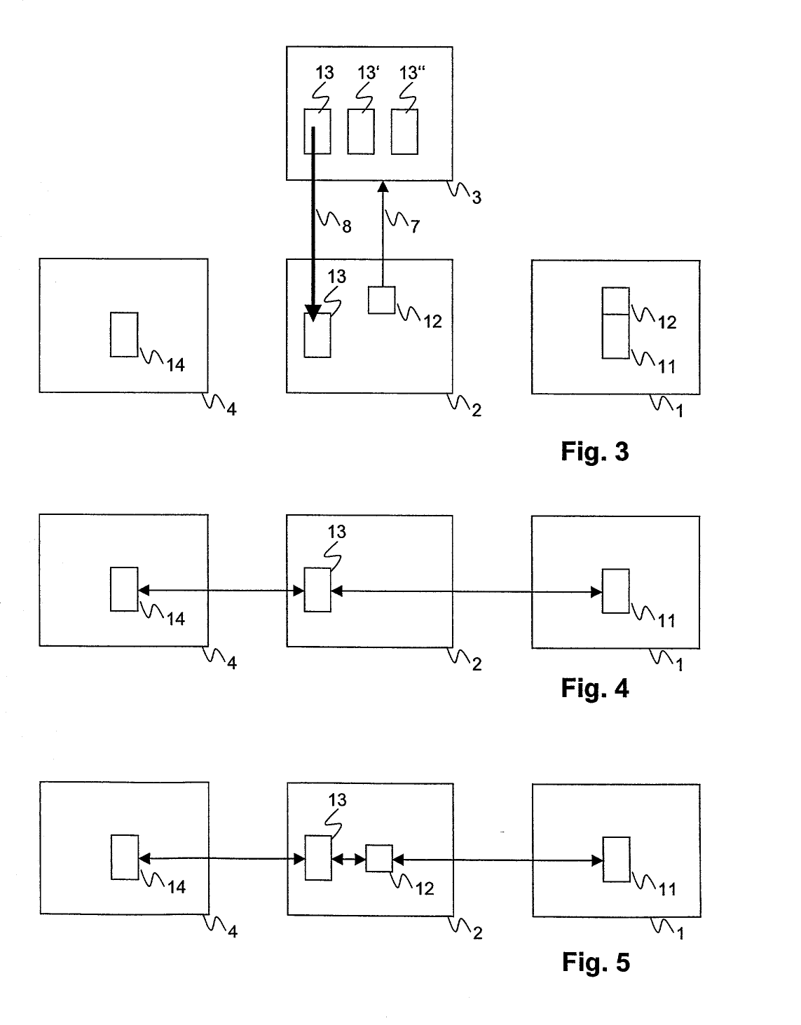

FIG. 3 shows, schematically, a second step in the method according to the invention. The component loader 12 has information about the type of business application 13 that is required, and the network address at which the component server 3 providing this business application 13 can be found. The component server 3 is preferably located with a producer of the appliance or of the control program 11. In a first variant of the method, the component loader 12 is executed on the application server 2 and sends an inquiry 7 to the component server 3, whereupon the component server 3 transmits the appropriate business application 13 from the plurality of business applications 13, 13′, 13″ stored on the component server 3 to the application server 2. In a second variant, the inquiry 7 to the component server 3 is generated by another program unit on the application server 2, using the information in the component loader 12. In both variants, after transmission 8 to the application server 2, the business application 13 is installed or loaded on the latter and is executed.

To create or set up a logical communication link to the client program 14, the component loader 12 enters itself, by way of example, in a list of appliances and services which are available or managed on the application server 2. When this list has been retrieved by the client program 14, the client program 14 connects to the appropriate business application 13.

FIGS. 4 and 5 show, schematically, the communication (already described) between the client program 14 and the control program 11 via the business application 13 after the method according to the invention has been carried out. The inquiries and responses interchanged during communication are represented by arrows. FIG. 4 shows a variant in which the business application 13 obtains the network address of the embedded server 1 from the component loader 12 and subsequently itself communicates with the control program 11. FIG. 5 shows another variant, in which communication is handled via the component loader 12, which contains the network address of the embedded server 1 and effects communication with the embedded server 1.

In summary, the method according to the invention thus proceeds by virtue of the embedded server 1, which has a control program 11 and a component loader 12, transmitting the component loader 12 to the application server 2. The component loader 12 transmits the business application 13 from a component server 3 to the application server 2, installs it there and executes it. The business application 13 effects communication between a client program 14, which is executed on a client computer 4, and the control program 11, which is executed on the embedded server 1.

The component loader 12 according to the invention, or the second program unit, is thus a computer program used to set up a communication link between the embedded server 1 of the appliance and the client computer 4. When this communication link is operating, a business application 13 on the application server 2 can be executed. The business application 13 has means for communicating with the client program 14 on the client computer 4 and with a control program 11 on the embedded server 1. The computer program can be stored on the embedded server 1 of the appliance. The computer program can be transmitted to the application server 2 and can be executed on the application server 2. The computer program has means for loading the business application 13 from the component server 3 into the application server 2.

The method according to the invention and the computer program according to the invention are suitable, for example, for managing data for locomotives in a railway company. For this purpose, an embedded server 1 on a locomotive has, amongst other things, a database in the control program 12. The database contains measured operating data and status information, diagnosis data and other data originating from analysis of the operating data, such as an available power and instances of failure which can be expected. The locomotives or their embedded servers 1 communicate with the application server 2 via a radio link on the basis of a GSM standard. The application server or its business application 13 serves one or more client computers 4 which can be used to retrieve the information for the locomotives. Access authorization for client programs 14 to the embedded servers 1 is monitored by the business application 13. If a respective locomotive is put into operation or enters a particular geographical region, the method according to the invention is carried out and a communication link to the application server 2 and the client computers 4 is thus set up. The component server 3 required is preferably located with a producer of the control programs 12. In this way, data for an entire fleet of locomotives can be displayed and processed further on one of the client computers 4. The communication links are also used to retrieve other data for individual locomotives and, if appropriate, to output control instructions to the locomotives.

A further application for the method according to the invention is in the field of distributed power generation, for example by means of microturbines. A site of microturbines, each equipped with an embedded server 1, is connected to an application server 2 over the Internet. The business applications for the various turbine types are set up on the basis of the method according to the invention. This reduces the level of effort for distribution and for updating the business applications.

1. A method for setting up a communication link between an embedded server (1) of an appliance and a client computer (4), where the embedded server (1) executes a control program (11) for controlling the appliance, and the client computer (4) executes a client program (14) for displaying data of the appliance and for entering control instructions to the appliance, and, when this communication link is operating, the control program (11) communicates with the client program (14) via a business application (13) which is executed on an application server (2), characterized in that the following steps are carried out to set up this communication:
a) a component loader (12) is transmitted from the embedded server (1) to the application server (2),
b) the component loader (12) causes the business application (13) to be transmitted from a component server (3) to the application server (2).

2. The method as claimed in claim 1, characterized in that the component loader (12) is transmitted from the embedded server (1) to the application server (2) using a network address stored in the embedded server (1).

3. The method as claimed in claim 1, characterized in that the component loader (12) is transmitted from the embedded server (1) to the application server (2) using a lookup server.

4. The method as claimed in claim 1, characterized in that, after transmission to the application server (2), the component loader (12) contains information about a network address for the embedded server (1).

5. The method as claimed in claim 1, characterized in that the component loader (12) contains information about a network address for the component server (3).

6. The method as claimed in claim 1, characterized in that the component loader (12) is executed on the application server (2), and thereby transmits the business application (13) from the component server (3) to the application server (2).

7. A computer program (12) for setting up a communication link between an embedded server (1) of an appliance and a client computer (4), where, when this communication link is operating, a business application (13) can be executed on an application server (2) and the business application (13) has means for communicating with a client program (14) on the client computer (4) and with a control program (11) on the embedded server (1), characterized in that the computer program (12) can be stored on the embedded server (1) of the appliance, the computer program (12) can be transmitted to the application server (2) and can be executed on the application server (2), and in that the computer program (12) has means for loading a business application (13) from a component server (3) into the application server (2).

8. The computer program (12) as claimed in claim 7, characterized in that the computer program (12) stores a network address for the component server (3).

9. The computer program (12) as claimed in claim 7, characterized in that the computer program (12) has means for loading the business application (13) from the component server (3) onto the application server (2).

10. The computer program (12) as claimed in claim 7, characterized in that the computer program (12) has means for communication between the business application (13) executed on the application server (2) and the control program (11).
